(19) United States
(12) Patent Application Publication
(10) Pub. No.: US 2021/0063807 A1
(43) Pub. Date: Mar. 4, 2021

(54) DISPLAY APPARATUS

(71) Applicant: Mitsubishi Electric Corporation, Tokyo (JP)

(72) Inventor: Yasuhiro ARAKI, Kumamoto (JP)

(73) Assignee: Mitsubishi Electric Corporation, Tokyo (JP)

(21) Appl. No.: 16/921,857

(22) Filed: Jul. 6, 2020

(30) Foreign Application Priority Data
Aug. 29, 2019 (JP) 2019-156390

(51) Int. Cl. G02F 1/1333

(52) U.S. Cl. CPC G02F 1/133308; G02F 1/13338; G02F 2202/28; G02F 2001/133317; G02F 2001/133331

(57) ABSTRACT

The display apparatus includes a front housing being a housing that surrounds the display panel and supports the display panel and the protective member. The front housing includes a tip portion in contact with the back surface being a curved surface of the protective member. At the tip portion of the front housing, there exist a contact region in contact with the back surface and a recess. The recess is provided from the contact region over to the side surface on the outer side of the front housing. An adhesive is provided in the recess. In order that the back surface of the protective member is fixed to the tip portion of the front housing with the adhesive, the adhesive is bonded to the back surface.

### BACKGROUND OF THE INVENTION

### Field of the Invention

The present invention relates to a display apparatus in which a protective member is fixed to a housing.

### Description of the Background Art

A display apparatus in which the display surface of the display panel is covered with a protective member (that is, a display apparatus having robustness) has been widely used. The protective member is made of resin or glass. In addition, display apparatuses for in-vehicle use are required to improve the design of the vehicle interior space. Therefore, a curved display apparatus having a configuration in which the display surface has an irregular shape and the display surface is a curved surface is becoming widespread.

The display apparatus generally includes a resin or metal frame that supports a display panel. In such a display apparatus, the width of the frame on the periphery of the display region is narrow in order to give priority to design. Therefore, the width of the frame of the frame is necessarily narrow.

The display apparatus is needed to be prevented from visibility deterioration due to surface reflection of external light and to be protected from external impacts, water immersion, dust, and the like. Thus, glass bonding (GB) technique of bonding the display surface of the display panel and the touch panel or the protective member to each other with a transparent resin is used for the display apparatus. This technique integrates the display panel and the touch panel or the protective member.

The protective member may be fixed to the display panel by a bonding member such as a double-sided adhesive tape. In this case, the display panel needs a region that can be joined to the protective member.

WO 2016/017141 discloses a configuration (hereinafter, also referred to as “related configuration A”) that maintains adhesive strength while achieving frame narrowing of the display unit. Specifically, in the related configuration A, a recessed portion is provided in the upper surface portion of the cabinet in order to increase a bonding area.

In a curved display apparatus, a protective member having a curved surface being curved is fixed to a housing surrounding a display panel with an adhesive. In the related configuration A, a gap that reaches up to the inner surface side of the housing exists between the cover as the protective member and the cabinet as the housing. Therefore, there is a problem that even if the related configuration A is applied to the curved display apparatus, the adhesive provided between the protective member (cover) and the housing (cabinet) may enter the inner surface side of the housing through the gap.

Thus, it is required that there is no gap between the curved surface of the protective member and the housing.

### SUMMARY

An object of the present invention is to provide a display apparatus in which there is no gap between the curved surface of the protective member and the housing.

A display apparatus according to an aspect of the present invention includes: a display panel including a display surface for displaying an image; a protective member provided on the display surface side of the display panel; and a housing configured to surround the display panel and to support the display panel and the protective member. The protective member has a curved surface being curved facing the display surface of the display panel. The housing includes a tip portion in contact with the curved surface of the protective member. A shape of the tip portion in a plan view is a closed-loop shape. A contact region in contact with the curved surface and a recess exist at the tip portion of the housing. The recess is provided from the contact region over to a side surface on an outer side of the housing. An adhesive is provided in the recess. The adhesive is bonded to the curved surface so that the curved surface of the protective member is fixed to the tip portion of the housing with the adhesive.

According to the present invention, the display apparatus includes a housing that surrounds the display panel and supports the display panel and the protective member. The housing includes a tip portion in contact with a curved surface of the protective member. At the tip portion of the housing, there exist a contact region in contact with the curved surface and a recess. The recess is provided from the contact region over to the side surface on the outer side of the housing. An adhesive is provided in the recess. In order that the curved surface of the protective member is fixed to the tip portion of the housing with the adhesive, the adhesive is bonded to the curved surface.

Thus, it is possible to provide a display apparatus in which there is no gap between the curved surface of the protective member and the housing.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view of the display apparatus according to a first preferred embodiment;

FIG. 2 is a bottom view of the display apparatus according to the first preferred embodiment;

FIG. 3 is a cross-sectional view of the display apparatus taken along line A1-A2 in FIG. 2;

FIG. 4 is a side view of the display apparatus in an assembled state according to the first preferred embodiment;

FIG. 5 is a bottom view of the display apparatus according to the first preferred embodiment;

FIG. 6 is a cross-sectional view of the display apparatus taken along line B1-B2 in FIG. 5;

FIG. 7 is a plan view showing a part of the display apparatus having the configuration of a first modification; and

FIG. 8 is a cross-sectional view of a display apparatus having the configuration of a second modification.

### DESCRIPTION OF THE PREFERRED EMBODIMENTS

Hereinafter, a preferred embodiment will be described with reference to the drawings. In the following drawings, the same components are denoted by the same reference numerals. It should be noted that the component denoted by the same reference numeral has the same or substantially the same function.

It should be noted that the dimensions, materials, and shapes of components exemplified in the preferred embodiment, relative arrangements of the components, and the like may be appropriately changed according to the configuration, various conditions, and the like of the apparatus. In addition, the dimensions of a component in a drawing may differ from the actual dimensions.

### First Preferred Embodiment

(Overall Configuration of Display Apparatus)

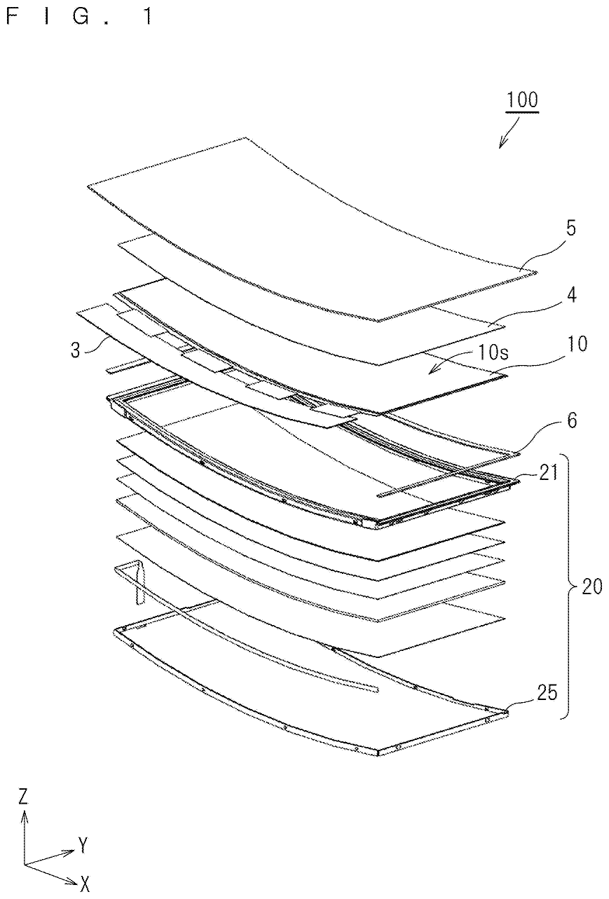

FIG. 1 is an exploded perspective view of the display apparatus 100 according to the first preferred embodiment. The display apparatus 100 is, for example, a liquid crystal display apparatus for displaying an image using liquid crystals. The display apparatus 100 is a curved display apparatus. It should be noted that the display apparatus 100 is not limited to a liquid crystal display apparatus, and may be a display apparatus of another system. The display apparatus 100 may be, for example, an organic EL display apparatus using an organic electroluminescence (EL) panel. Hereinafter, a state in which a plurality of components of the display apparatus 100 shown in FIG. 1 are assembled is also referred to as an “assembled state”.

In FIG. 1, the X direction, the Y direction, and the Z direction are orthogonal to one another. The X, Y, and Z directions illustrated in the following drawings are also orthogonal to one another. Hereinafter, a direction including the X direction and a direction opposite to the X direction (−X direction) is also referred to as “X-axis direction”. In addition, hereinafter, a direction including the Y direction and a direction opposite to the Y direction (−Y direction) is also referred to as “Y-axis direction”. In addition, hereinafter, a direction including the Z direction and a direction opposite to the Z direction (−Z direction) is also referred to as “Z-axis direction”.

In addition, hereinafter, a plane including the X-axis direction and the Y-axis direction is also referred to as “XY plane”. In addition, hereinafter, a plane including the X-axis direction and the Z-axis direction is also referred to as “XZ plane”. In addition, hereinafter, a plane including the Y-axis direction and the Z-axis direction is also referred to as “YZ plane”.

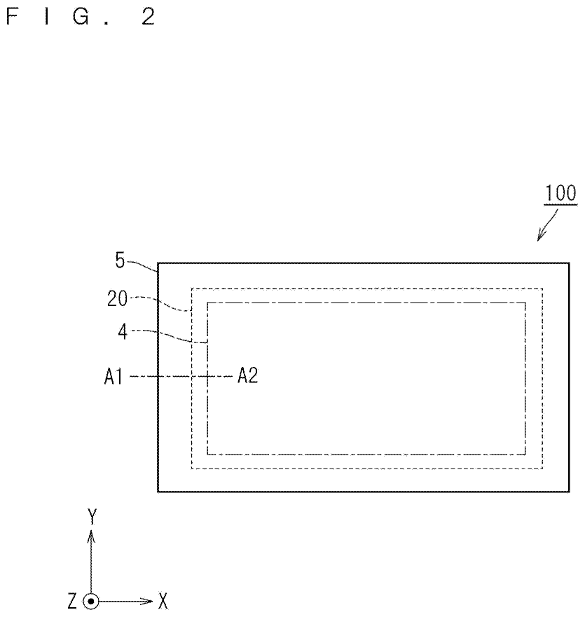

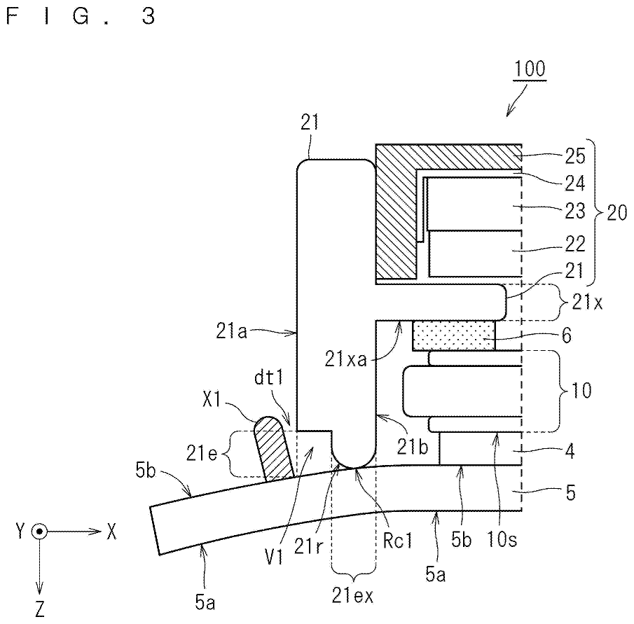

FIG. 2 is a bottom view of the display apparatus 100 according to the first preferred embodiment. Specifically, FIG. 2 is a diagram, as viewed from the protective member 5 side, of the state in which the display apparatus 100 is arranged so that the below-mentioned protective member 5 of the display apparatus 100 in the assembled state is at the bottom. FIG. 3 is a cross-sectional view of the display apparatus 100 taken along line A1-A2 in FIG. 2.

With reference to FIGS. 1, 2, and 3, the display apparatus 100 includes a display panel 10, a touch panel 4, a protective member 5, a planar light source apparatus 20, and a circuit board 3. The display panel 10 includes a display surface 10s for displaying an image (video). The touch panel 4 and the protective member 5 are provided on the display surface 10s side of the display panel 10.

The touch panel 4 has a screen. The touch panel 4 accepts a touch operation on the screen. In this case, the touch panel 4 transmits a position signal indicating the touch position on the screen to, for example, a control unit (not shown). The protective member 5 is a member that protects the touch panel 4. The protective member 5 is made of a transparent material having translucency. The transparent material includes glass, plastic, or the like.

It should be noted that the display apparatus 100 does not need to include the touch panel 4. In this case, the protective member 5 protects the display panel 10.

Although the details will be described below, the planar light source apparatus 20 includes a front housing 21. The front housing 21 supports the display panel 10. In addition, a cover (not shown) may be provided on the rear surface of the display panel 10. The cover protects the circuit board 3 of the display panel 10.

Next, each of the members constituting the display apparatus 100 will be described in more detail.

(Display Panel)

The display panel 10 is a liquid crystal display panel. It should be noted that the display panel 10 is not limited to the liquid crystal display panel. For example, when the display apparatus 100 is an organic EL display apparatus, the display panel 10 may be an organic EL panel. The liquid crystal display panel is a panel to which birefringence of the liquid crystal material is applied. The liquid crystal display panel includes a first substrate (not shown) and a second substrate (not shown). The first substrate is an insulating substrate such as glass. A color filter (CF), a light shielding layer, a counter electrode, and the like are formed on the first substrate.

The second substrate is an insulating substrate such as glass. A switching element, a pixel electrode, and the like are formed on the second substrate. The switching element is a thin film transistor (TFT).

The display panel 10 further includes a spacer (not shown), a seal material (not shown), a liquid crystal layer (not shown), a sealing material (not shown), an alignment film (not shown), a polarizing plate (not shown), and a driving IC (not shown).

The first substrate and the second substrate are provided to face each other. The spacer is provided to generate a predetermined space between the first substrate and the second substrate. The seal material is a member for sticking the first substrate and the second substrate to each other. The liquid crystal layer is sandwiched between the first substrate and the second substrate.

The sealing material is a member that seals an injection port for injecting liquid crystals. The alignment film is a film for aligning liquid crystals constituting the liquid crystal layer. The polarizing plate is provided on the outer side surface of the first substrate. In addition, the polarizing plate is also provided on the outer side surface of the second substrate.

The driving IC is provided in a rim portion of the second substrate. It should be noted that the driving IC may be provided on a tape-shaped wiring material (TCP, COF, and the like) connected to the rim portion of the second substrate.

(Planar Light Source Apparatus)

The planar light source apparatus 20 includes a front housing 21. As shown in FIG. 3, the front housing 21 supports the display panel 10.

The planar light source apparatus 20 irradiates light toward the back surface of the display panel 10. The planar light source apparatus 20 further includes a light source (not shown), an optical sheet 22, a light guide plate 23, a reflection sheet 24, and a rear housing 25.

The light source emits light. The light guide plate 23 guides the light emitted from the light source in a specific direction. The light guide plate 23 is a member for guiding light to the optical sheet 22. The light guide plate 23 has a side surface, an emitting surface, and an anti-emitting surface. The emitting surface is a surface from which light is emitted. The anti-emitting surface is a surface opposite to the emitting surface in the light guide plate 23. The light emitted from the light source is incident on the light guide plate 23 from the side surface of the light guide plate 23. Most of the light incident on the light guide plate 23 is emitted from the emitting surface of the light guide plate 23 toward the display panel 10.

The optical sheet 22 is provided on the emitting surface of the light guide plate 23. The optical sheet 22 controls the distribution and spread of the light emitted from the light guide plate 23. The reflection sheet 24 is a sheet that reflects light. The light emitted from the anti-emitting surface of the light guide plate 23 is reflected by the reflection sheet 24, and is incident on the light guide plate 23 again. The rear housing 25 holds the optical sheet 22, the light guide plate 23, and the reflection sheet 24.

(Light Source)

The light source is a point-like light source, an LED, a fluorescent tube lamp, or the like. The point-like light source emits RGB (three primary colors) light. RGB light includes red light, green light, and blue light. When the point-like light source is used, a light source substrate on which the point-like light source is mounted is used. The light source substrate is made of a general glass epoxy resin as a base.

It should be noted that in order to improve the heat dissipation of the light source substrate, the light source substrate may be made of a metal such as aluminum, or a ceramic, as a base. When a point-like light source is used, a flexible flat cable may be used. The LED emits light different from RGB light (for example, white light).

(Light Guide Plate)

The light guide plate 23 is made of a transparent material. The transparent material is acrylic resin, polycarbonate resin, glass, or the like. A light scattering portion is formed on one or both of the emitting surface and the anti-emitting surface of the light guide plate 23. The light scattering portion has a structure for emitting light from the emitting surface and adjusting the intensity distribution of light in the surface, the emission direction of light, and the like. The light scattering portion is, for example, a scattering dot pattern. In addition, the light scattering portion has, for example, a prism shape.

(Optical Sheet)

The optical sheet 22 is provided on the emitting surface of the light guide plate 23, as described above. The optical sheet 22 is a member for adjusting the intensity distribution of outgoing light, the outgoing angle of light, and the like.

The optical sheet 22 is configured by using a required number of lens sheets, diffuser sheets, viewing angle adjusting sheets, and the like according to the purpose. The lens sheet is used for collecting light. The diffuser sheet is used for light homogenization. The viewing angle adjusting sheet is used for adjusting the brightness of light in the viewing angle direction.

(Front Housing)

The front housing 21 has an opening through which the light emitted by the planar light source apparatus 20 passes. As shown in FIGS. 1 and 3, the shape of the front housing 21 in a plan view (XY plane) is a closed-loop shape (frame shape).

The front housing 21 is made of metal. The metal is, for example, aluminum, stainless steel, iron, or the like. It should be noted that the front housing 21 may be made of a resin material. The resin material is polycarbonate (PC), acrylonitrile butadiene styrene (ABS), or the like.

(Rear Housing)

The rear housing 25 positions and holds a light source (not shown) and a light source substrate (not shown). In order to conduct the heat emitted from the light source, the rear housing 25 is made of metal having high thermal conductivity. The metal having high thermal conductivity is, for example, aluminum or aluminum alloy. The rear housing 25 made of metal having high thermal conductivity efficiently dissipates heat from the light source of the light source substrate. Thus, it is possible to prevent heat from being trapped in the planar light source apparatus 20.

The front housing 21 and the rear housing 25 are generally fixed to each other by a hooking structure using a claw, a screw clamp, or the like. Thus, another planar surface light source apparatus member, the display panel 10, the circuit board 3 and the like are held. It should be noted that the front housing 21 and the rear housing 25 may be integrated.

(Circuit Board)

The circuit board 3 controls the display panel 10, the light source, and the like with electrical input/output signals. The circuit board 3 is manufactured as follows. For example, a copper pattern is formed on glass epoxy or the like. Then, electronic components are mounted on the front surface of the glass epoxy or the like by soldering. The circuit board 3 is mainly arranged and fixed on the back surface side (the side from which light is not emitted) of the display apparatus 100.

It should be noted that the circuit board 3 may be configured by mounting electronic components on a flexible printed circuit (FPC). The FPC is obtained by forming wiring lines on a base material on a film connected to the display panel M.

In addition, a protective cover (not shown) may be attached to the circuit board 3 in order to protect the circuit board 3 from external pressure, static electricity, and the like. The protective cover is made of, for example, metal or film-shaped thin resin. The metal is aluminum, stainless steel, galvanized steel plate, or the like. In addition, the resin is polyethylene terephthalate (PET) or the like.

It should be noted that when a metal protective cover is used, it is necessary to avoid electrical contact with the circuit board 3 and electronic components on the circuit board 3. Thus, it is desirable that a resin sheet such as PET is attached to the circuit board 3 side and insulation measures are taken.

(Touch Panel)

The touch panel 4 includes a transparent substrate and a circuit including a transparent electrode formed on the transparent substrate. The touch panel 4 converts information related to position coordinates input from the outside (user) into an electrical signal with the above circuit. Then, the touch panel 4 transmits the electric signal to the control circuit (not shown) of the final product via the output wiring portion connected to the end portion of the touch panel 4.

An FPC is used as an output wiring portion from the degree of freedom of connection due to thinness and flexibility thereof. It should be noted that the output wiring portion is not limited to the FPC. The output wiring portion may be made of different materials and structures as long as it has the same function and characteristics as FPC.

In addition, in order to prevent damage, deformation, wear, dirt, and the like due to external pressure, contact, and the like on the input surface side of the touch panel 4, a protective member 5 is provided on the input surface side of the touch panel 4. It should be noted that a light shielding member may be printed on the rim portion of the front surface or the back surface of the protective member 5 for a light shielding purpose or a design purpose.

(Characteristic Configuration)

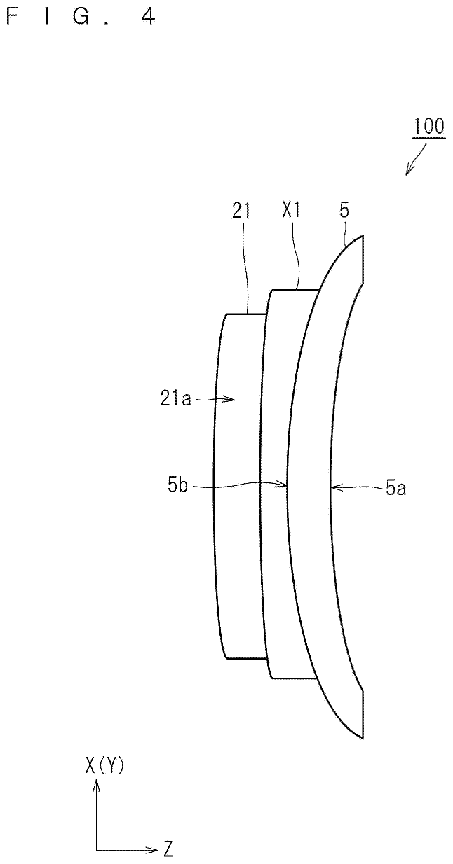

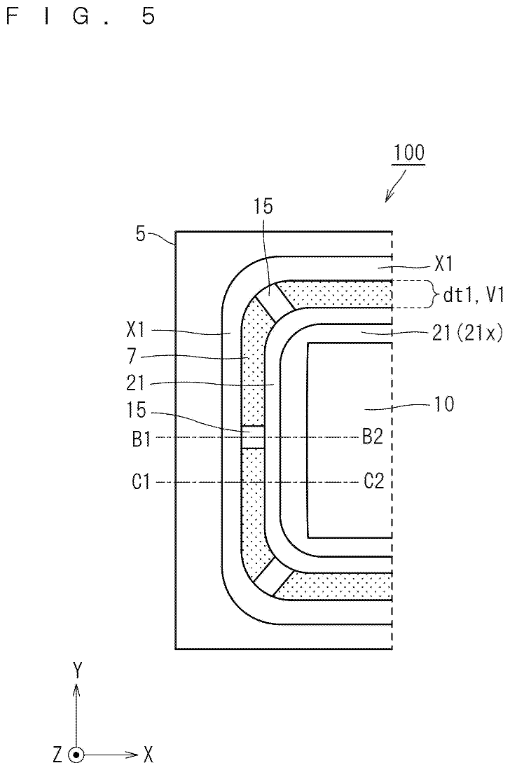

Next, the characteristic configuration of the present preferred embodiment will be described in detail. FIG. 4 is a side view of the display apparatus 100 in an assembled state according to the first preferred embodiment. FIG. 5 is a bottom view of the display apparatus 100 according to the first preferred embodiment. Specifically, FIG. 5 is a diagram, as viewed from the protective member 5 side, of a state in which the display apparatus 100 is arranged so that the protective member 5 of the display apparatus 100 in the assembled state is at the bottom. It should be noted that in FIG. 5, “dt1, V1” indicates a region including a gap dt1 and a recess V1 described below.

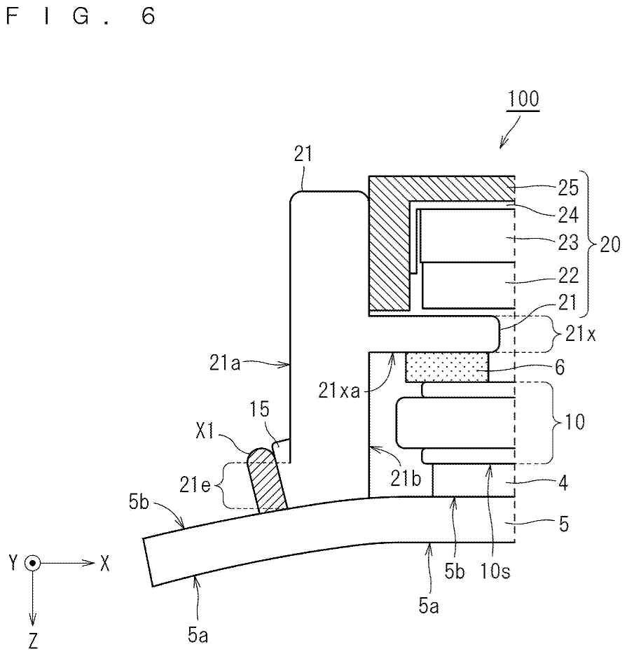

FIG. 6 is a cross-sectional view of the display apparatus 100 taken along line B1-B2 in FIG. 5. It should be noted that FIG. 3 is also a cross-sectional view of the display apparatus 100 taken along line C1-C2 in FIG. 5. It should be noted that in FIG. 3, the adhesive 7 described below is not shown in order to make the configuration near the recess V1 described below easier to understand.

With reference to FIGS. 3, 4, 5, and 6, the protective member 5 is obtained by curving a plate-shaped member. The protective member 5 has a front surface 5a and a back surface 5b. In the protective member 5, the back surface 5b is a surface opposite to the front surface 5a. Each of the front surface 5a and the back surface 5b is a curved surface. The curved surface is a curved surface. The back surface 5b being a curved surface faces the display surface 10s of the display panel 10 (see FIG. 3).

The front housing 21 is a housing that surrounds the display panel 10. In addition, the front housing 21 supports the display panel 10 and the protective member 5.

First, the configuration in which the front housing 21 supports the display panel 10 will be described in detail. The front housing 21 includes a protruding portion 21x for supporting the display panel 10 (see FIG. 3). The protruding portion 21x protrudes toward the space inside the display apparatus 100. The protruding portion 21x extends in a direction along the display surface 10s of the display panel 10. That is, the protruding portion 21x extends in a direction parallel to the display surface 10s of the display panel 10. The protruding portion 21x has a plate shape.

The protruding portion 21x has a surface 21xa facing the rim portion of the display panel 10. An adhesive member 6 is provided on the surface 21xa. The adhesive member 6 is, for example, a double-sided tape. The adhesive member 6 provided on the surface 21xa of the protruding portion 21x is adhered to the rim portion of the display panel 10. With the above configuration, the protruding portion 21x of the front housing 21 supports the display panel 10 with the interposition of the adhesive member 6.

Next, a configuration in which the front housing 21 supports the protective member 5 will be described in detail. The front housing 21 includes a tip portion 21e in contact with the back surface 5b (curved surface) of the protective member 5. As described above, the shape of the front housing 21 in a plan view (XY plane) is a closed-loop shape (frame shape), In addition, the shape of the tip portion 21e in a plan view is a closed-loop shape (frame shape).

The tip portion 21e of the front housing 21 includes a contact portion 21ex. The contact portion 21ex is a part of the tip portion 21e. A contact region Rc1 in contact with the back surface 5b (curved surface) and a recess V1 exist at the tip portion 21e of the front housing 21.

It should be noted that the contact portion 21ex includes a contact region Rc1. In addition, the contact portion 21ex includes an R portion 21r including the contact region Rc1. Therefore, the contact portion 21ex is configured such that, in the contact portion 21ex, the closer a portion to the contact region Rc1, the smaller the cross-sectional area of the portion.

In addition, the front housing 21 has a side surface 21a as an outer surface and a side surface 21b as an inner surface. The side surface 21a is a side surface on the outer side of the front housing 21. It should be noted that the contact region Rc1 of the contact portion 21ex is closer to the side surface 21b as the inner surface than the recess V1. That is, the recess V1 is farther from the side surface 21b than the contact region Rc1 of the contact portion 21ex.

The recess V1 existing in the tip portion 21e of the front housing 21 is provided from the contact region Rc1 over to the side surface 21a. The recess V1 is recessed from the side surface 21a toward the space inside the display apparatus 100.

Hereinafter, in the front surface of the R portion 21r of the contact portion 21ex, a region closer to the side surface 21a than the contact region Rc1 is also referred to as an “outer front surface”. For example, the outer front surface in FIG. 3 is, in the front surface of the R portion 21r, a region on the left side of the contact region Rc1. In addition, hereinafter, the gap between the outer front surface of the R portion 21r and the back surface 5b of the protective member 5 is also referred to as “R portion gap”. The R portion gap is included in the recess V1.

The recess V1 exists in the closed-loop shaped tip portion 21e in a plan view. Therefore, the shape of the recess V1 in a plan view is a closed-loop shape (frame shape). In a plan view, the recess V1 is formed over the whole periphery of the closed-loop shaped tip portion 21e (front housing 21).

Although details will be described below, an adhesive 7 is provided in the recess V1 in FIG. 3. The adhesive 7 is a cured resin. The adhesive 7 is a resin cured by ultraviolet rays, heat, moisture, and the like. Hereinafter, the state of the adhesive 7 in a condition where the adhesive 7 is not cured is also referred to as “non-cured state”. The adhesive 7 in a non-cured state has fluidity, adhesive strength, and viscosity. In addition, hereinafter, the state of the adhesive 7 in a condition where the adhesive 7 is cured is also referred to as “cured state”. The adhesive 7 in a cured state does not have fluidity or viscosity.

Here, it is assumed that the adhesive 7 is, for example, an ultraviolet curing resin. In this case, irradiating the adhesive 7 in a non-cured state with ultraviolet rays cures, in the adhesive 7, a portion irradiated with ultraviolet rays.

In addition, a wall X1 is provided on the back surface 5b (curved surface) of the protective member 5 (see FIG. 3). The wall X1 is a member that surrounds the recess V1 of the tip portion 21e of the front housing 21. The shape of the wall X1 in a plan view is a closed-loop shape (frame shape) (see FIGS. 1 and 5).

It should be noted that the length corresponding to the height of the wall X1 is not less than the length corresponding to the depth of the recess V1. In addition, the wall X1 is provided on the back surface 5b (curved surface) so that a gap dt1 exists between the side surface 21a on the outer side of the front housing 21 where the recess V1 is provided and the wall X1 (see FIG. 3). The gap dt1 is also a hollow portion. The gap dt1 extends to the back surface 5b. The shape of the gap dt1 in a plan view is a closed-loop shape (frame shape) (see FIGS. 1 and 5).

It should be noted that in a plan view, a plurality of columnar members 15 are arranged at intervals in the closed-loop shaped gap dt1 and the recess V1 (see FIGS. 5 and 6). The plurality of columnar members 15 support the wall X1.

Each columnar member 15 has a shape for the columnar member 15 to fill the gap dt1 and the recess V1 in the region where the columnar member 15 exists (see FIG. 6). The columnar member 15 has a shape for filling the gap dt1 and the recess V1 in FIG. 3, for example. Therefore, the gap dt1 and the recess V1 do not exist in the region where the columnar member 15 exists.

Each columnar member 15 is integrated with the front housing 21 in the region where the columnar member 15 exists. It should be noted that each columnar member 15 does not have to be integrated with the front housing 21 in the region where the columnar member 15 exists.

In addition, the height of each columnar member 15 is the identical to the height of the wall X1. It should be noted that the expression “the height of each columnar member 15 is the same as the height of the wall X1” also includes the meaning that the height of each columnar member 15 is equivalent to the height of the wall X1.

Hereinafter, the region including the gap dt1 and the recess V1 is also referred to as “bonding region”. The bonding region is a region for filling with the adhesive 7. The bonding region is, for example, a region surrounded by the wall X1, the back surface 5b of the protective member 5, and the contact portion 21ex in FIG. 3. In addition, the bonding region is, for example, a region including the gap dt1 and the recess V1 specified by the reference numeral “dt1, V1” in FIG. 5.

In addition, in the bonding region in FIG. 5, the region between two adjacent columnar members 15 is a part of the bonding region. FIG. 5 shows a state in which the adhesive 7 is filled in the bonding region.

Hereinafter, the state of the bonding region when the bonding region is not filled with the adhesive 7 is also referred to as “non-filled state”. In addition, hereinafter, the state of the bonding region when the bonding region is filled with the adhesive 7 is also referred to as “filled state”.

In addition, hereinafter, the state of the display apparatus 100 completed in manufacturing is also referred to as “product state”. In the display apparatus 100 in a product state, the bonding region is filled with the adhesive 7. In addition, in the display apparatus 100 in the product state, the protective member 5 is fixed to the front housing 21 with the adhesive 7. Hereinafter, the state of the display apparatus 100 not completed in manufacturing is also referred to as “non-product state”.

Next, a filling and bonding step for filling the bonding region with the adhesive 7 will be described with reference to FIG. 3. Here, description will be made assuming that the bonding region in FIG. 3 is not filled with the adhesive 7.

The filling and bonding step is performed in a state where the front housing 21 and the protective member 5 are arranged as shown in FIG. 3. The gap dt1 in FIG. 3 is used as an injection port for the adhesive 7. It should be noted that the filling and bonding step will be described assuming that the adhesive 7 is, for example, an ultraviolet curing resin.

In the filling and bonding step, first, a nozzle (not shown) is inserted into the gap dt1 as an injection port. The nozzle has a function of ejecting the adhesive 7 in a non-cured state.

Then, the nozzle ejects the adhesive 7 in a non-cured state. Therefore, the bonding region including the gap dt1 and the recess V1 is filled with the adhesive 7 in a non-cured state from the gap dt1. Thus, in FIG. 3, the adhesive 7 is provided in the recess V1 included in the bonding region.

Next, the adhesive 7 in a non-cured state is irradiated with ultraviolet rays. Thus, in order that the back surface 5b (curved surface) of the protective member 5 is fixed to the tip portion 21e of the front housing 21 with the adhesive 7, the adhesive 7 is bonded to the back surface 5b. With the above, the filling and bonding step ends, and the state of the display apparatus 100 becomes a product state. In addition, the protective member 5 is fixed to the front housing 21 with the adhesive 7.

In the display apparatus 100 in a product state, the adhesive 7 is provided in the recess V1 included in the bonding region in FIG. 3, for example. In addition, the adhesive 7 is bonded to the back surface 5b so that the back surface 5b (curved surface) of the protective member 5 is fixed to the tip portion 21e of the front housing 21 with the adhesive 7.

### SUMMARY

As described above, according to the present preferred embodiment, the display apparatus includes a front housing 21 being a housing that surrounds the display panel 10 and supports the display panel 10 and the protective member 5. The front housing 21 includes a tip portion 21e in contact with the back surface 5b being a curved surface of the protective member 5. At the tip portion 21e of the front housing 21, there exist a contact region Rc1 in contact with the back surface 5b and a recess V1. The recess V1 is provided from the contact region Rc1 over to the side surface 21a on the outer side of the front housing 21. An adhesive 7 is provided in the recess V1. In order that the back surface 5b of the protective member 5 is fixed to the tip portion 21e of the front housing 21 with the adhesive 7, the adhesive 7 is bonded to the back surface 5b.

Thus, it is possible to provide a display apparatus in which there is no gap between the curved surface of the protective member and the housing.

In addition, according to the present preferred embodiment, the adhesive 7 is filled in the bonding region in the filling and bonding step. It should be noted that the back surface 5b (curved surface) of the protective member 5 is in contact with the contact region Rc1 of the contact portion 21ex of the front housing 21. Therefore, it is possible to prevent the adhesive 7 from entering the inside of the display apparatus 100 (for example, the side surface 21b side of the front housing 21).

In addition, a wall X1 is provided on the back surface 5b (curved surface) of the protective member 5. Therefore, it is possible to prevent the adhesive 7 from dripping and flowing toward outside the display apparatus 100. That is, after the bonding region is filled with the adhesive 7, the wall X1 supported by the columnar member 15 can prevent the dripping flow of the adhesive 7 along the back surface 5b as the curved surface. Therefore, it is possible to prevent the bonding area shortage due to filling shortage of the adhesive 7 with respect to the recess V1 included in the bonding region.

It should be noted that the adhesive 7 spreads over the recess V1 including the R portion gap in the front housing 21, and is also fixed to the back surface 5b of the protective member 5. Therefore, it is possible to secure the bonding area to fix the protective member 5 to the front housing 21.

In addition, according to the present preferred embodiment, an adhesive member 6 is provided on the surface 21xa of the protruding portion 21x, and the adhesive member 6 is adhered to the rim portion of the display panel 10. Therefore, it is possible to obtain an adhesive strength such that the protective member 5 does not fall off during the transportation of the display apparatus in the step. Therefore, it is possible to transport the display apparatus to the next step without waiting for the adhesive 7 in a non-cured state to be cured.

It should be noted that in the above-described related configuration A, a recessed portion to be provided with an adhesive is provided on the upper surface portion of the cabinet as a housing. However, a gap is provided between the cover as a protective member and the cabinet as a housing. Therefore, even if the related configuration A is applied to the curved display apparatus, the following problems exist.

Specifically, in a case where a protective member having a curved-curved surface is fixed to a housing (cabinet) with the adhesive, when the adhesive has a low viscosity, the adhesive drips to flow along the curved surface.

Thus, there is a possibility that a situation where the adhesive enters the inside of the display apparatus, a situation where the adhesive protrudes outside the display apparatus, and the like. When the adhesive enters the inside of the display apparatus, there is a problem that the display quality is deteriorated. In addition, when the adhesive protrudes outside the display apparatus, there is a problem that the appearance of the display apparatus is deteriorated.

In addition, immediately after the adhesive is applied and before the adhesive is cured, the adhesive strength is low. Therefore, during the transportation of the display apparatus in the step, there is a problem that the protective member (cover) falls off during the period from the application of the adhesive to the hardening of the adhesive.

Thus, the display apparatus 100 of the present preferred embodiment has a configuration for producing the above-described effect. Therefore, each of the above problems can be solved by the display apparatus 100 of the present preferred embodiment. As a result, for example, when the curved protective member is fixed to the housing, it is possible to prevent the adhesive from dripping and flowing into the inside of the display apparatus and the outside of the display apparatus.

It should be noted that the recess V1 of the present preferred embodiment does not have to be formed over the whole periphery of the closed-loop shaped tip portion 21e (front housing 21). The recess V1 may be provided to be divided into several places in the closed-loop shaped tip portion 21e (front housing 21). That is, the shape of the recess V1 in a plan view may be a shape other than the closed-loop shape.

<First Modification>

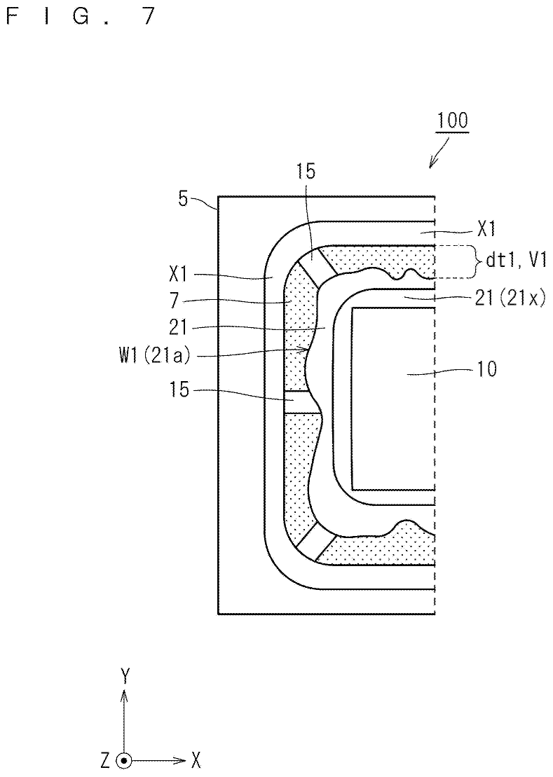

The configuration of the present modification is applied to the first preferred embodiment. FIG. 7 is a plan view showing a part of the display apparatus 100 having the configuration of the first modification. The configuration in FIG. 7 is a configuration in which the configuration of the present modification is applied to the configuration in FIG. 5.

In the first preferred embodiment, the R portion 21r is provided at the contact portion 21ex of the tip portion 21e of the front housing 21. In the present modification, the R portion 21r is not provided at the contact portion 21ex of the tip portion 21e.

It should be noted that a recess V1 exists on the side surface 21a of the front housing 21. In the present modification, a corrugated portion W1 having an uneven shape is provided on the side surface 21a of the front housing 21. That is, the shape of the side surface 21a in a plan view is an uneven shape. Therefore, in a plan view, a recess, a protrusion, and the like exist on the side surface 21a.

As described above, according to the present modification, the provision of the corrugated portion W1 can prevent the adhesive 7 from spreading at the contact region Rc1 of the contact portion 21ex of the front housing 21. Therefore, it is possible to secure a wide bonding area while preventing the adhesive 7 from entering the inside of the display apparatus 100.

<Second Modification>

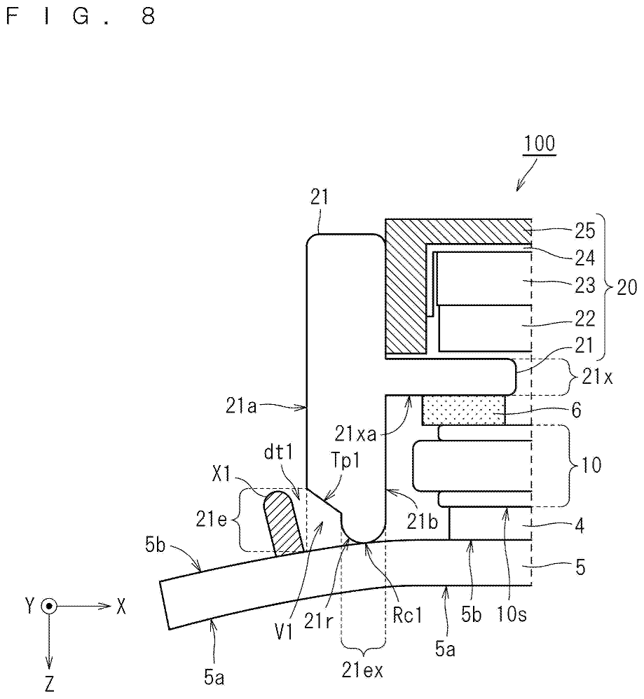

The present modification is applied to the first preferred embodiment. FIG. 8 is a cross-sectional view of a display apparatus 100 having the configuration of the second modification. It should be noted that FIG. 8 is a cross-sectional view of the display apparatus 100 taken along line C1-C2 in FIG. 5.

In the present modification, the bottom of the recess V1 is a slope Tp1 as a tapered surface. The slope Tp1 extends to the side surface 21a on the outer side of the front housing 21.

As described above, according to the present modification, the bottom of the recess V1 is the slope Tp1. The slope Tp1 extends to the side surface 21a on the outer side of the front housing 21. Thus, in the filling and bonding step described above, when the adhesive 7 is filled in the bonding region, the nozzle (not shown) described above can be easily inserted into the gap dt1 as an injection port.

### Other Modifications

It should be noted that in the present invention, the preferred embodiment and each of the modifications can be freely combined, and the preferred embodiment and each of the modifications can be appropriately modified or omitted within the scope of the present invention.

For example, the columnar member 15 may have a shape for the columnar member 15 to fill only the gap dt1 in the region where the columnar member 15 exists. That is, the columnar member 15 may have a shape for the columnar member 15 not to fill the recess V1 in the region where the columnar member 15 exists.

While the invention has been shown and described in detail, the foregoing description is in all aspects illustrative and not restrictive. It is therefore understood that numerous modifications and variations can be devised without departing from the scope of the invention.

What is claimed is:

1. A display apparatus comprising:
a display panel including a display surface for displaying an image;
a protective member provided on the display surface side of the display panel; and
a housing configured to surround the display panel and to support the display panel and the protective member,
wherein the protective member has a curved surface being curved facing the display surface of the display panel,
wherein the housing includes a tip portion in contact with the curved surface of the protective member,
wherein a shape of the tip portion in a plan view is a closed-loop shape,
wherein a contact region in contact with the curved surface and a recess exist at the tip portion of the housing,
wherein the recess is provided from the contact region over to a side surface on an outer side of the housing,
wherein an adhesive is provided in the recess, and
wherein the adhesive is bonded to the curved surface so that the curved surface of the protective member is fixed to the tip portion of the housing with the adhesive.

2. The display apparatus according to claim 1, wherein the curved surface of the protective member is provided with a wall for surrounding the recess of the tip portion.

3. The display apparatus according to claim 2,
wherein a length corresponding to a height of the wall is not less than a length corresponding to a depth of the recess, and
wherein the wall is provided on the curved surface so that a gap exists between the side surface on the outer side of the housing where the recess is provided and the wall.

4. The display apparatus according to claim 3,
wherein a shape of the gap in a plan view is a closed-loop shape,
wherein in a plan view, a plurality of columnar members are arranged at intervals in the gap having a closed-loop shape, and
wherein a height of each of the columnar members is identical to a height of the wall.

5. The display apparatus according to claim 1,
wherein the tip portion of the housing includes a contact portion including the contact region, and
wherein in the contact portion, the contact portion is configured such that the closer a portion to the contact region, the smaller a cross-sectional area of the portion.

6. The display apparatus according to claim 1,
wherein the recess exists on the side surface of the housing, and
wherein a shape of the side surface in a plan view is an uneven shape.

7. The display apparatus according to claim 1,
wherein a bottom of the recess is a slope, and
wherein the slope extends to the side surface on the outer side of the housing.

8. The display apparatus according to claim 1,
wherein the housing includes a protruding portion for supporting the display panel,
wherein the protruding portion extends in a direction along the display surface of the display panel, and
wherein the protruding portion supports the display panel with interposition of an adhesive member.

9. The display apparatus according to claim 1, wherein a shape of the recess in a plan view is a closed-loop shape.
